(19) United States
(12) Patent Application Publication
(10) Pub. No.: US 2021/0354081 A1
(43) Pub. Date: Nov. 18, 2021

(54) ATMOSPHERIC MOISTURE TRAP

(71) Applicant: Santiago José MIRALLES CANO, Santa Cruz de Tenerife (ES)

(72) Inventor: Santiago José MIRALLES CANO, Santa Cruz de Tenerife (ES)

(21) Appl. No.: 16/627,070

(22) PCT Filed: Jul. 30, 2019
(86) PCT No.: PCT/ES2019/070540

§ 371 Date: Dec. 27, 2019

(30) Foreign Application Priority Data
Sep. 11, 2018 (ES) U201831366

(51) Int. Cl. B01D 53/26; B01D 71/02; B01D 69/06

(52) U.S. Cl. CPC B01D 53/268; B01D 2257/80; B01D 69/06; B01D 71/022

(57) ABSTRACT

An atmospheric moisture trap of condensation from a liquid fluid material in suspension which is conveyed by its own force towards the atmospheric moisture trap; where the trap comprises a lower storage receptacle disposed in the lower portion of the atmospheric moisture trap; at least one upper structure mechanically coupled to at least one inner surface of the lower storage receptacle in vertical manner, where the upper structure within the lower storage receptacle condenses liquid fluid material, which is temporarily stored within the lower storage receptacle; and the upper structures are mechanically coupled to the lower storage receptacle vertically and spaced parallelly by a predetermined distance D equidistant within the lower storage receptacle.

### PURPOSE

The present invention relates to an atmospheric moisture trap condenser of a liquid fluid material, sensitive to the cold, present in suspension within a mass of humid ambient air. The atmospheric moisture trap allows the heat transfer between itself and the liquid fluid material acting as crystallization initiator until forming ice crystals on a structure of the atmospheric moisture trap which acts as crystallization support.

### STATE OF THE ART

It is known in the state of the art that any atmospheric air includes a percentage of water vapour which can be used for consumption, when the mass of humid air is passed through an atmospheric moisture trap of the ambient moisture which comprises a casing with a main intake and another of outlet between is established a forced airflow; in the casing there is a cold apparatus dimensioned to make the airflow temperature reduce below dew point to condense the moisture it carries; an air-air exchanger to make use of the residual cold of the now dehydrated outflow from the cooling element of the cooling apparatus to pre-cool the inflow; and a turbine or fan generating the forced in/out air flow through the respective inlet/outlet; there is also a condensed water collector in the casing.

One disadvantage of current devices arises from the use of equipment that require electricity to work, both in the ventilation stage, and in the compression stage. Consequently, the current condenser devices have a CO₂ footprint and also contain greenhouse gases in their circuit.

In surroundings with not very high dew points, complex installations are resorted to that demand power to generate cold artificially by forced ventilation.

### SUMMARY

The present invention seeks to resolve one or more of the aforementioned drawbacks by an atmospheric moisture trap as defined in the claims, which, without the need to provide power, allows water collection with a high yield in environments with negative temperatures close to zero degrees Celsius or centigrade and with reduced absolute humidities.

The atmospheric moisture trap without external power supply comprises a crystallization initiator support with a predetermined calorific capacity due to the specific heat parameter of the material, at least one multilaminar support that retains the atmospheric humidity and allows continuity in the humidity transfer.

The multilaminar support comprises at least one decreasing mesh space or opening in adjacent multilaminar supports in the form of meshes which allow slowing down a humid flow which traverses the successive multilaminar supports to increase the humidity transfer time.

The atmospheric moisture trap captures water from a mass of atmospheric air from a continuous method to condense a suspension of vapour fluid material within the mass of atmospheric air sensitive to the cold, based on the decrease in temperature of the mass of air below the dew point, in environments where the temperature is below 0° C. and is dose to dew point.

The atmospheric moisture trap is mobile, easy to install outside, modular, capable of operating without power supplied from an external infrastructure thereto, being maintained with minimum technical skills, resistant to climatic conditions and supplies water from ambient humidity when the temperature is sub-zero and the dew point is low.

The mass of air hitting the atmospheric moisture trap does not necessarily have to be saturated, since condensation starts on the atmospheric moisture trap with approximate relative humidity percentages higher than 70%.

The atmospheric moisture trap has dimensions that allow its transport; its preparation and use are simple and it requires minimum infrastructure; it can be used in a wide variety of environments where the already described humidity and temperature conditions may be present.

The upper structure is dimensioned to allow the heat transfer from atmospheric humidity and acts as crystallization initiator support, allowing the condensation from water in negative temperature conditions close to 0° C. and relative humidity over 70%.

The freezing of the liquid fluid material would delay the collection of the fluid material within the lower storage receptacle. In a scenario where the condensed fluid material freezes, solid phase of the fluid material, the change of solid-liquid phase occurs as the atmospheric moisture trap increases its surface temperature; with the liquid phase of the fluid material being stored in the lower part of the same device.

Consequently, the accumulation of frost or rime ice allows the capture of liquid when the dew point is low. In general, a low dew point occurs predominantly in cold environments. The cold air contains a low absolute moisture. However, it has a sufficiently high relative humidity to be condensed in the atmospheric moisture trap.

The atmospheric moisture trap is intercalated in the circulation of the mass of humid atmospheric air; i.e. the larger dimension of the upper structure shall be disposed orthogonally and frontally to the predominant direction of the trajectory of circulation of the mass of humid atmospheric air; acting as physical support of interaction with the mass of air and consequent condensation of the fluid material in suspension by heat exchange between both.

The atmospheric moisture trap is designed to be installed in the open air where the fluctuations in ambient temperature are those desired; withstanding sub-zero temperatures and operating at temperatures close to freezing point.

The condensed fluid material in solid and/or liquid phase passes from the upper condenser structure to the lower storage tank by gravity. The separate ice crystals pass from the cold rods of the upper structure to the lower storage tank after passing through solid phase to liquid phase.

The atmospheric moisture trap condenses liquid fluid material in suspension which descends by gravity towards the lower storage receptacle disposed in the lower portion of the atmospheric moisture trap and at least one upper structure mechanically coupled to the lower storage receptacle in vertical manner within the lower storage receptacle to collect previously condensed liquid fluid material, which is temporarily stored within the lower storage receptacle.

A plurality of upper structures is mechanically coupled to the lower storage receptacle vertically and spaced parallelly by a predetermined distance “D” equidistant within the lower storage receptacle.

The upper structure is made in a thin, flexible metal material, formed by the quadrangular cross-linking of long and thin rods that form empty through-holes.

The rods are disposed in quadrangular-shaped metal mesh and can be of smooth, corrugated or similar rod-type.

The material of the atmospheric moisture trap is of corrosion-resistant galvanized type; the upper structure being of galvanized, electrowelded or similar mesh type of different thicknesses and different mesh openings, both of decreasing size from the front part to the rear.

The upper structures remain parallel and stable at a predetermined distance “D” to the front upper structure and a rear upper structure by mechanical fixing elements, which are of vertical guide type disposed on the inner surface of the lower storage receptacle.

The empty through-holes form an air-permeable casing in the form of a parallelepiped structure with an entry façade and an exit façade parallel to the sides of shorter length of the lower storage receptacle, providing a flow of decreasing velocity, allowing a progressive transfer of the moisture to the atmospheric moisture trap.

The atmospheric moisture trap is disposed orthogonally to the flow of liquid fluid material, which is conveyed by its own force and the upper structure may have any geometric form filled with empty through-holes disposed in decreasing size of necessary dimensions so that the mass of air with fluid matter in suspension sensitive to the cold gradually impacts against the rods.

### BRIEF DESCRIPTION OF FIGURES

A more detailed explanation is given in the following description and which is based on the attached figures:

FIG. 1 shows a perspective view of an atmospheric moisture trap disposed orthogonally to the direction of a fluid material that comprises a liquid material in suspension; and

FIG. 2 shows a schematic perspective view of two separate adjacent parallel upper structures with decreasing dimensions of hollow empty mesh holes.

### DESCRIPTION

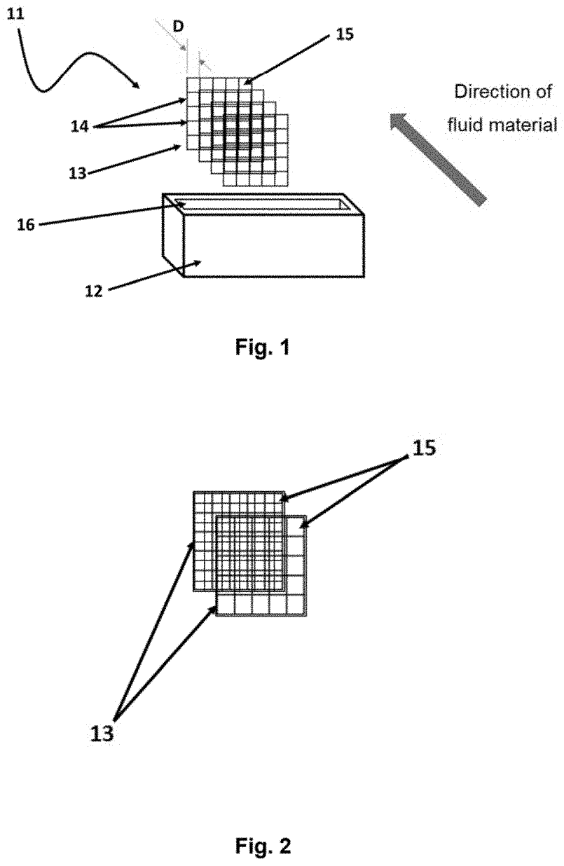

In relation to FIG. 1, where it shows an atmospheric moisture trap 11 of condensation from liquid material in suspension within a gaseous fluid material that comprises a plurality of upper structures 13 whereon the liquid material is condensed and descends by gravity towards a lower storage receptacle 12 of the atmospheric moisture trap 11.

The lower storage receptacle 12 occupies the lower portion of the atmospheric moisture trap 11 and has a rectangular-type parallelepiped form. The plurality of upper structures 13 are vertically fixed to the lower storage receptacle 12 and are parallelly spaced by a predetermined distance “D” equidistant within the lower storage receptacle 12. The condensed liquid material is stored temporarily within the lower storage receptacle 12.

The upper structure 13 is made in a thin, flexible metal material, formed by the cross-linking of long and thin rods 14 that form empty through-holes 15, for example, in the form of a parallelogram; i.e. the upper structure 13 has a metal mesh form comprising the plurality of through-holes 15, where the cross-linked rods 14 are of different thicknesses and mesh openings, forming a structure with an increasing specific surface. i.e. greater mesh surface per unit of volume the farther away the upper structure 13 is from the first upper structure 13 that receives the gaseous fluid material.

The material of the mesh is of corrosion-resistant galvanized type; with the mesh being of electrowelded mesh, galvanized or similar type.

The upper structures 13 remain parallel and a front upper structure 13 is separated from a rear upper structure 13 by mechanical fixing elements such as vertical guides disposed on the inner surface of the storage receptacle 12 to mechanically couple the upper structures 13 to the lower storage receptacle 12.

In consequence, the storage receptacle 12 comprises an upper opening 16 of dimensions such that it allows that the upper structures 13 can be vertically inserted by sliding and perpendicularly to the inner surfaces of the parallel sides of shorter length of the storage receptacle 12 through the upper opening 16 to be mechanically coupled to the inner surfaces of the sides of shorter length.

The plurality of upper structures 13 is disposed parallelly so that the empty through-holes 15 form an air-permeable volume in parallelogram form with an entry front and an exit front of parallelepiped type, with a decreasing section in cross-section made throughout a longitudinal axis parallel to the sides of shorter length of the lower storage receptacle, according to the direction of advance of the air; shown in FIG. 1.

In relation now to FIG. 2, the fluid material impacts with decreasing velocity, by its own impulsion, gradually against the rods 14 that form empty mesh holes 15, also decreasing, which, in turn, also have opposing rods or rods that do not coincide with the front or rear rods of the upper structures 13. As the humid fluid material is channelled it passes through the empty holes 15 by its own force, the moisture is condensed on the rods 14 against which it impacts and thermally interacts.

The upper structure 13 may have any rectangular geometric form, quadrangular full of empty through-holes 15 adopting a progressive decrease in dimensions necessary so that the mass of air with fluid humid matter in suspension sensitive to the cold passes through them to be condensed.

The upper structure 13 of metal material is capable of acting as progressive condensation support at sub-zero temperatures and close to dew point, of a flow of incoming air, continuously, through the base of greatest area of the structure formed by a row of empty through-holes 15, to cause the condensation from liquid material on the surfaces of the upper structures 13; with the liquid material later descending through the upper opening 16 within the lower storage receptacle 12.

Similarly, both the atmospheric moisture trap 11 and the lower storage receptacle 12 are also made in a galvanized metal material or similar, extremely resistant to corrosion.

The atmospheric moisture trap 11 exerts a gradual action to condense a liquid suspension by heat transfer thereof on the rods 15 of the upper structure 13 and the resulting frozen material be later removed.

In short, the atmospheric moisture trap 11 comprises the upper head-conductor metal structure 13 initiator of the crystallization, that makes use of the natural cold and acts by condensing the existing moisture in the ambient air and turning it into frost on the structure and which later pours by gravity to the lower storage receptacle 12.

Furthermore, said atmospheric structure additionally has the virtue of being effective as it exercises a multiplying effect of the precipitations collected per square metre if they arise.

1. An atmospheric moisture trap of condensation from a flow of liquid fluid material in suspension which is conveyed by its own force towards the atmospheric moisture trap (11); characterized in that the atmospheric moisture trap (11) comprises a lower storage receptacle (12) disposed in the lower portion of the atmospheric moisture trap (11); at least two upper structures (13) mechanically coupled to an inner surface of the lower storage receptacle (12) in vertical manner, where the upper structures (13) are disposed parallel one to the other, made in a metal material, comprising a plurality of empty through-holes (15) that form an air-permeable volume in parallelogram form with an entry front and an exit front of parallelepiped type, with a decreasing section in cross-section made throughout a longitudinal axis parallel to the sides of shorter length of the lower storage receptacle (12), according to the direction of advance of the air, which provides cold to start the crystallization of the liquid fluid material in suspension.

2. Device as claimed in claim 1, characterized in that the upper structure (13) may have any geometric form with empty through-holes (15) disposed in decreasing dimensions, according to the direction of advance of the air, so that the mass of air with fluid matter in suspension sensitive to the cold impacts against the rods (14) in slow mode.

3. Device as claimed in claim 1, characterized in that the upper structure (13) is thin, flexible and formed by the cross-linking of long and thin rods (14) that form empty through-holes (15).

4. Device as claimed in claim 3, characterized in that the rods (14) are disposed in metal mesh form are of smooth, corrugated or similar rod-type.

5. Device as claimed in claim 4, characterized in that the material of the mesh is of corrosion-resistant galvanized type; with the mesh being of flat mesh type, in squares of variable width, electrowelded mesh, folded rigid panel or similar.

6. Device as claimed in claim 5, characterized in that the upper structure (13) supplies water within the lower storage receptacle (12) after the ice crystals formed on the upper structure (13) passing from solid phase to liquid phase when the ambient temperature is higher than 0° C.

7. Device as claimed in claim 1, characterized in that the upper structures (13) are mechanically coupled to the lower storage receptacle (12) vertically and spaced parallelly by a predetermined distance D equidistant within the lower storage receptacle (12).

8. Device as claimed in claim 7, characterized in that the upper structures (13) remain parallel and separate from a front and a rear by mechanical fixing elements.

9. Device as claimed in claim 8, characterized in that the mechanical fixing elements are of the vertical guide type disposed on the inner surface of the lower storage receptacle (12).

10. Device as claimed in claim 9, characterized in that the atmospheric moisture trap (11) is disposed orthogonally to the flow of liquid fluid material which is conveyed by its own force towards the upper structures (13).
